(19) United States
(12) Patent Application Publication
(10) Pub. No.: US 2022/0038024 A1
(43) Pub. Date: Feb. 3, 2022

(54) POWER SUPPLY APPARATUS FOR IMPROVING QUALITY AND PRECISION OF OUTPUT CHARACTERISTICS

(71) Applicant: Rohde & Schwarz GmbH & Co. KG, Munich (DE)

(72) Inventors: Juergen WALDSCHMITT, Mönchberg (DE); Sascha KUNISCH, Haibach (DE); Philipp WEIGELL, Baierbrunn (DE)

(21) Appl. No.: 16/940,588

(22) Filed: Jul. 28, 2020

(51) Int. Cl. H02M 7/219; H02M 3/156; H02M 1/08; H02M 1/42

(52) U.S. Cl. CPC H02M 7/219; H02M 1/4233; H02M 1/083; H02M 3/156

(57) ABSTRACT

A power supply comprising a transformer unit for transforming an AC voltage and AC current input on a primary side of the transformer unit into an AC voltage and AC current for supplying a load connectable to a secondary side of the transformer unit, a controllable switch controlled by a switch signal, and a processing unit. The processing unit is configured to generate the control signal based on a zero crossing information signal, further based on a set output voltage and/or a set output current, and further based on an actual output voltage and/or an actual output current.

### TECHNICAL FIELD

The invention regards a power supply apparatus providing energy to electrical loads.

### BACKGROUND

Modern electric or electronic equipment in many cases is not capable to directly connect to mains power supply as such mains usually offers only a supply voltage as an alternating voltage on the level which is not directly usable for the equipment. Thus, dedicated power supply devices need to be either integrated into the respective apparatus or be separately provided in order to generate a voltage and current that is suitable for operating the equipment. The quality of such power supplies increases continuously by further developing and optimizing already known techniques. One aspect is that for economic reasons it is necessary that the loss generated in the power supply unit has to be kept low. On the other hand, depending on the equipment that shall be provided with electric energy by such a power supply unit, the requirements regarding quality of the provided voltage stability or current can be quite demanding.

One type of power supply which has often been used in the past is a so-called switch mode power supply (SMPS), because such power supplies have advantages when compared to simple transformers known in the art for a long time.

On the other hand, dimming techniques are known where an input voltage needs to be reduced in order to provide an apparatus or, to be more general, a load at a desired voltage level. Such an approach is known for example from EP 1465464 A2. The adjustment of the voltage level is achieved by using phase cut or phase section techniques.

However, all currently known approaches still leave room for improvement, specifically regarding quality and precision of the output characteristics.

### SUMMARY

Embodiments of the present invention advantageously address the foregoing requirements and needs, as well as others, by providing a power supply apparatus that provides energy to electrical loads and improves quality and precision of the output characteristics.

With the present invention it is possible to improve the output characteristics, in particular, to reduce the periodic and random deviation (PARD). The improvement is achieved by a power supply comprising a transformer unit and a controllable switch on the secondary side of the transformer. The controllable switch is controlled by a signal that is generated based on calculations performed in a processing unit, wherein this processing unit is configured to generate the control signal based on a zero crossing information signal, further based on a set output voltage and/or a set output current and additionally based on an actual output voltage and/or an actual output current.

The transformer unit transforms an AC voltage and AC current input on a primary side of the transformer unit into an AC voltage and AC current for supplying a load connectable to the secondary side of the transformer unit. Using the controllable switch on the secondary side of the transformer allows to superimpose a phase cut technique and/or if a phase section technique on the secondary side of the transformer. Being controlled by a control signal that is generated by a processing unit based on a target value for the voltage (set voltage) and/or for the current (set current) but also taking into consideration measurements of the actual output voltage and/or current allows to precisely adjust the output of the power supply unit. Further, compared to a well-known SMP the ripple at the output side of the power supply is reduced as well as its noise. Thus, the electrical characteristics of the inventive power supply units are improved over the state-of-the-art solutions. For precisely adjusting the output feedback from the output side is used by providing the measured information to the processing unit so that the processing unit (e.g. a processor) can adjust the timing of the phase cut or phase section of the signal generated by the transformer itself relative to the reference indicated by the zero crossing information.

Further advantageous aspects are defined in the dependent claims.

According to one preferred aspect, the power supply comprises a rectifier unit on the secondary side of the transformer unit. Using such a rectifier unit on the secondary side has the advantage that contrary to state-of-the-art solutions rectification followed by a high frequency switching of the rectified voltage becomes unnecessary. Using a transformer being connected to a mains supply on its primary side is possible, and further adjustments of the electrical output values of the output power are done on the secondary side only.

According to another advantageous aspect, the processing unit is configured to determine at least one of: overpower, shortage and deviation from line voltage. The processing unit is provided with all the information that is necessary to internally calculate deviations from target values and thus conclude whether overpower, shortage or deviation from line voltage is currently encountered. The feedback loop, feeding back information regarding an actual voltage provided for a load at output terminals of the power supply and preferably also an output current flowing on the output side which is measured by respective sensing means, delivers all necessary information to determine on the events listed above. Thus, measuring output values allows to obtain information on the primary side because the characteristics of the transformer unit are static and thus it is possible to derive the input side values from the measured output side values taking into consideration the currently set timing and duty cycle of phase cutting and/or phase sectioning.

Further, the processing unit is configured to calculate a power factor. This calculated power factor can be used to refine the adjustment of the control signal in order to achieve a reduction of the difference between the calculated actual power factor and a predefined power factor that might be understood as a target power affect.

According to another advantageous aspect, the power supply comprises an interface for receiving data defining the set output voltage and/or the set output current. Such an interface allows in a very easy way that a user may adapt the set of values for the output voltage and the output current. Alternatively, the power supply may comprise integrated means for inputting the desired values into the processing unit.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

Exemplary embodiments of the invention are now further explained with respect to the drawings by way of example only, and not for limitation. In the drawings:

FIG. 1 shows a block diagram as one example for a power supply according to the present invention; and

FIG. 2 shows exemplary curves for explaining phase cut and phase section used on the secondary side of a transformer unit.

### DETAILED DESCRIPTION

A power supply apparatus that provides energy to electrical loads and improves quality and precision of the output characteristics, is provided. In the following description, for the purposes of explanation, numerous specific details are set forth in order to provide a thorough understanding of the invention. It is apparent, however, that the invention may be practiced without these specific details or with an equivalent arrangement. In other instances, well-known structures and devices are shown in block diagram form in order to avoid unnecessarily obscuring the invention.

A processor, unit, module or component (as referred to herein) may be composed of software component(s), which are stored in a memory or other computer-readable storage medium, and executed by one or more processors or CPUs of the respective devices. A module or unit may alternatively be composed of hardware component(s) or firmware component(s), or a combination of hardware, firmware and/or software components. Further, with respect to the various example embodiments described herein, while certain of the functions are described as being performed by certain components or modules (or combinations thereof), such descriptions are provided as examples and are thus not intended to be limiting. Accordingly, any such functions may be envisioned as being performed by other components or modules (or combinations thereof), without departing from the spirit and general scope of the present invention. Moreover, the methods, processes and approaches described herein may be processor-implemented using processing circuitry that may comprise one or more microprocessors, application specific integrated circuits (ASICs), field programmable gate arrays (FPGAs), or other devices operable to be configured or programmed to implement the systems and/or methods described herein. For implementation on such devices that are operable to execute software instructions, the flow diagrams and methods described herein may be implemented in processor instructions stored in a computer-readable medium, such as executable software stored in computer memory storage.

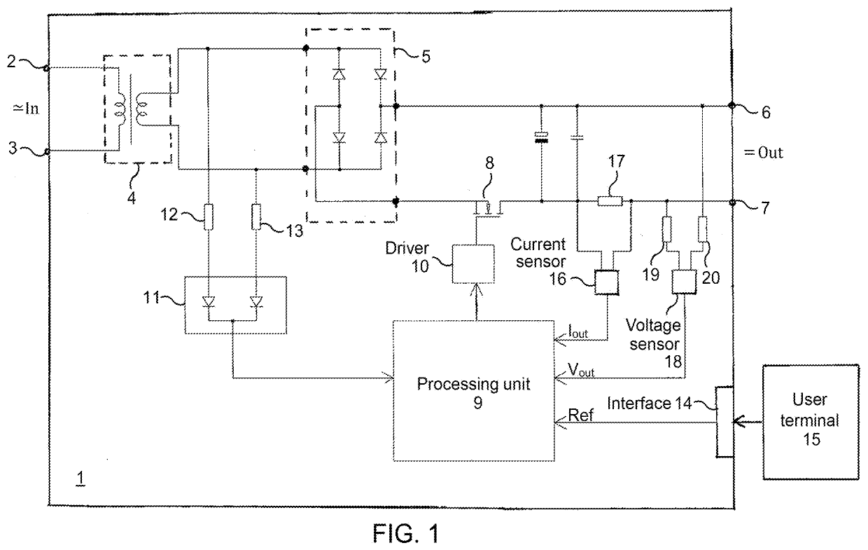

FIG. 1 shows an example of the inventive power supply according to a preferred embodiment. The power supply 1 is provided with electrical energy via a first terminal 2 and a second terminal 3. The first and second terminals 2, 3 are connected with the primary side of a transformer unit 4. The transformer unit 4 comprises a first conductor coupled with a second inductor which is the secondary side of the transformer unit 4. Depending on the ratio of the windings of the first and second inductors, the input AC voltage and current will be transferred to an AC voltage and current on the output side, namely the secondary side of the transformer unit 4.

The secondary side of the transformer unit 4 is connected with a rectifier unit 5. In the illustrated embodiment the rectifier unit 5 is a full bridge rectifier. The output terminals of the rectifier unit 5 are connected with output terminals 6 and 7 of the power supply 1. Thus, in the preferred and illustrated embodiment the alternating input voltage and current are transformed and rectified so that at the output side the direct current and voltage are available for supplying the load.

However, it is to be noted that for implementing the invention it is not necessary to include the rectifier unit 5 but to provide a power supply unit which outputs an alternating current and voltage. However, according to the invention the output alternating current and voltage in such an embodiment also has the advantage to be improved regarding its electrical characteristics because of an adjustment of the output is performed by phase cutting and/or phase sectioning of the transformed alternating voltage and current on the secondary side of the transformer unit 4 as it will be explained in greater detail below. The calculation of the duty cycle and timing of the phase cutting and/or phase sectioning uses information received from the feedback of the measured electrical output values.

According to the present invention, on the secondary side of the transformer unit 4, a controllable switch 8 is provided. The controllable switch 8 is included in the line connecting the rectifier unit 5 with the second output terminal 7. However, the controllable switch 8 may also be provided in the other line, connecting the second output terminal of the rectifier unit 5 with the first output terminal 6 of the power supply 1.

The controllable switch 8 may for example be a MOSFET so that providing the control signal to the gate of the MOSFET enables switching the MOSFET in a conducting and in a nonconducting operation mode. Thus, the connection between one output terminal of the rectifier unit 5 and the respective output terminal 7 of the power supply 1 may be interrupted according to the control signal that is provided to the controllable switch 8 thereby allowing to execute phase cutting and/or phase sectioning of the transformed voltage.

In order to switch on and off the controllable switch 8 and dedicated times relative to the current phase of the transformed AC voltage, a processing unit 9 is provided which controls the timing of the control signal. In the illustrated embodiment the control unit 9 outputs a control signal to a driver 10, which post processes the control signal before it is applied to the gate of the controllable switch 8. it is to be noted that direct control of the controllable switching unit 8 is also possible. By switching on and off the controllable switch 8, a phase cut operation or phase section operation is achieved.

In order to find the right point in time when to switch on or off the controllable switch 8, it is necessary to know a reference time point of the phase of the alternating voltage at the secondary side of the transformer unit 4. A suitable reference is the time point of zero crossing AC voltage at the secondary side of the transformer unit 4. The zero crossing of the AC voltage is determined by using a zero crossing detection unit 11 connected via resistors 12, 13 with the first and second output terminals of the transformer unit 4, respectively. The processing unit 9 is configured to receive the zero crossing detection signal to calculate, based on the known outputs of the transformer unit 4 and target values for the desired output voltage and/or output current that are input via an interface 14, the switching time and duty cycle relative to the time reference obtained by the zero crossing detection unit 11.

The interface 14 is connected to a user terminal 15, for example, a personal computer, where the user can input the desired output current and output voltage (target values). However, other ways to input desired voltages and currents are also possible, in particular input means included in the power supply 1.

In addition, the processing unit 9 is provided with information on actual output values for the current and the voltage. The actual output current is sensed by the current sensor 16 based on a measurement of a voltage drop over a resistor 17. On the other hand, a differential measurement is performed by the voltage sensor 18 being connected to the first output terminal and the second output terminal 6, 7 via respective further resistors 19, 20. Thus, in addition to time information on the zero crossing, the processing unit 9 also obtains information about a target value for the output voltage and/or output current and measured actual values for the actual output voltage and the actual output current.

The processing unit 9 then calculates, based on the above listed input information, the timing for switching the controllable switch 8 and generates a respective control signal. By comparing the actual measured values for the output current and the output voltage with the target values, which are set by inputting values via the user terminal 15, an adjustment of the switching time of the controllable switch 8 can be performed. Thus, it is even possible to readjust the timing of switching in order to perfectly match the desired output values. The control signal is generated as a rectangular signal switching between low-level and high-level at the calculated points in time defining the phase of the alternating current output by the transformer unit 4 which may be calculated as a time interval starting from the determined time of the zero crossing.

Since a feedback loop is used to adjust the control signal for controlling the controllable switch 8 in order to refine the adjustment of the voltage output by the transformer unit 4 at is even possible to compensate variation at the input side of the transformer unit 5. Thus, the output voltage and current can be precisely adjusted to match the desired values.

Further, the measured values for the actual current and actual output voltage allow to calculate a power factor and to adjust the duty cycle and switching time of the controllable switch 8 and boarded to adjust the actually calculated power factor to a predefined power factor value.

Further, exceptional conditions may be identified by analyzing the information provided to the processing unit 9. In particular, overvoltage, shortage and/or deviation from line voltage can be determined by analyzing the measured actual values that result from the settings and known input voltage on the primary side. For example, the input terminals 2 and 3 are connected to mains that has 230 V at 50 or 60 Hz. Without considering any deviation from these input values, output values of the power supply unit 1 may change in line with a variation of the duty cycle and the timing of switching off the controllable switch 8. The characteristics of the transformer unit 4 a static and known in advance and cannot influence variation of the output. Thus, having knowledge of the currently set duty cycle and timing of switching of the controllable switch 8, the characteristics of the transformer unit 4, which are constant, and the measured values of the actual output voltage and actual output current allows to determine exceptional situations like overvoltage, shortage or deviation from line voltage. The processing unit 9 may be configured to output a signal to initiate an alert using for example a display or a control LED or the like.

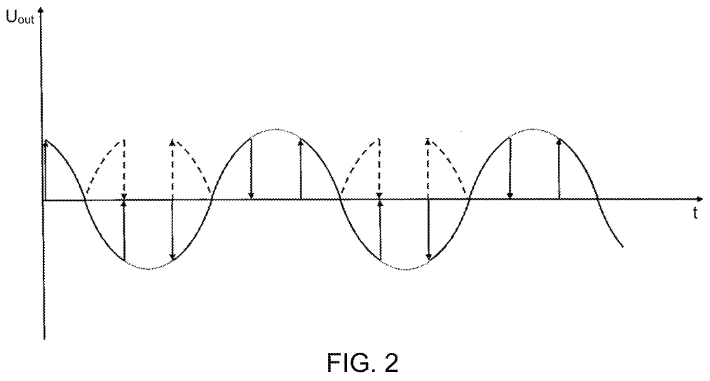

Usually, adjustment of the output voltage is performed by performing either phase cutting or phase sectioning. However, it is also possible to combine both techniques as it will be now shown with reference to FIG. 2. FIG. 2 quantitatively shows the curve of the AC voltage at the output side of the transformer unit 4. It is to be noted that the specific illustration refers to a power supply, which does not include the rectifier unit 5 shown in FIG. 1. Of course, it may easily be understood that the very same applies in case that the rectifier unit 5 is present. In that case, namely a full bridge rectifier like the one designated with reference numeral 5 in FIG. 1, the negative half wave would be mirrored as it is indicated by the dashed curve.

With the determined point in time where the AC voltage at the output of the transformer unit 4 process the zero line, a reference for a phase of the AC voltage is obtained. The timing for switching the controllable switch 8 on and off can be determined as a phase of the AC voltage and maybe monitored by measuring the time interval from the last zero crossing, for example.

It is particularly preferred to set the time points for switching the controllable switch 8 symmetrically around the maximum of the AC voltage curve. Starting from a theoretical curve of the secondary side values for the current and the voltage first, and initial timing and duty cycle for the control signal is calculated. Then, the set values for the output voltage and output current are compared with the measured actual output current and measured actual output voltage. An adjustment of the duty cycle and/or timing of the switching of the controllable switch 8 is then performed based on the determined deviation from the target values for the current and voltage. The adaptation may be done iteratively and incrementally, particularly cycle by cycle. larger increments may be used if the deviation exceeds a certain threshold. Iteratively reducing the deviation results in precisely matching the desires current and voltage values.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

1. A power supply comprising:
a transformer unit for transforming an AC voltage and AC current input on a primary side of the transformer unit into an AC voltage and AC current for supplying a load connectable to a secondary side of the transformer unit;
a controllable switch controlled by a switch signal; and
a processing unit configured to generate the switch signal based on a zero crossing information signal, further based on a set output voltage and/or a set output current, and further based on an actual output voltage and/or an actual output current.

2. The power supply according to claim 1, wherein the power supply comprises:
a rectifier unit on the secondary side.

3. The power supply according to claim 1, wherein the processing unit is configured to determine overpower, shortage and/or deviation from line voltage.

4. The power supply according to claim 1 wherein the processing unit is configured to calculate a power factor.

5. The power supply according to claim 4, wherein the processing unit is configured to adjust the switch signal taking into account the calculated power factor.

6. The power supply according to claim 1, wherein the power supply comprises:
an interface for receiving data defining the set output voltage and/or the set output current.
